(19) United States
(12) Patent Application Publication
(10) Pub. No.: US 2014/0101150 A1
(43) Pub. Date: Apr. 10, 2014

(54) EFFICIENT HIGH PERFORMANCE SCALABLE PIPELINED SEARCHING METHOD USING VARIABLE STRIDE MULTIBIT TRIES

(71) Applicant: Axis Semiconductor, Inc., Boxborough, MA (US)

(72) Inventors: Xiaolin Wang, Concord, MA (US); Qian Wu, Redwood City, CA (US); Benjamin Marshall, Stowe, MA (US); Rajib Ray, Weymouth, MA (US)

(21) Appl. No.: 13/921,416

(22) Filed: Jun. 19, 2013

Related U.S. Application Data
(60) Provisional application No. 61/710,198, filed on Oct. 5, 2012.

(51) Int. Cl. G06F 17/30

(52) U.S. Cl. CPC G06F 17/30386
USPC 707/736

(57) ABSTRACT

A method for high speed searching of a large database provides speed, throughput, and efficient memory usage comparable to TCAM-assisted searches without using dedicated processors. Successive groups of bits from a key are processed by tables in a search tree. The tables are constructed with different sizes and types according to the structure of the key and the distribution of information in the database. Each link to a subsequent table specifies both the type of the linked table and how many key bits the table will process. The tables include, but are need not be limited to, address offset tables that use bits from the key as an addressing offset to locate a result. Embodiments are implemented on pipeline processors that include internal memory units and access to external memory. Embodiments also include string compare tables, memory mapped tables, and/or instructions to continue searching on a different memory unit.

### RELATED APPLICATIONS

This application claims the benefit of U.S. Provisional Application No. 61/710,198, filed Oct. 5, 2012, which is herein incorporated by reference in its entirety for all purposes.

### FIELD OF THE INVENTION

The invention relates to methods of searching for data, and more particularly, to methods for locating data within large databases.

### BACKGROUND OF THE INVENTION

Methods for locating a data result within a large data collection have existed for centuries, and have been applied to a wide range of fields. For small data collections, the typical method is to identify a search term or “key,” and then to successively match the key against each item in the data collection until the result is found. This direct approach is referred to herein as a “memory map.” Larger data collections are often organized into structures, such that certain elements of the key direct the search to a sub-group of the data collection, while other elements of the key are used to match particular items in the sub-group. For example, if one wished to find a biography of Napoleon in a library of bound volumes, one might mentally choose “Biography Napoleon” as the key. The first part of the key indicates the section of the library where the book will be located, while the second part indicates the particular book being sought, so that one would first proceed first to locate the section of the library that contains “biographies,” and would then proceed to find the appropriate shelf (for example containing titles beginning with L-P), and would finally match the name “Napoleon” against the individual titles on the shelf. Of course, one possible outcome could be that no biography of Napoleon is carried by that library, but the result of the search would still be successful, in that it would conclusively determine whether or not a biography of Napoleon existed in the library.

Of course, most data searches are carried out by computers searching databases stored in non-transient memory. Applications range from internet searches (which are actually searches of very large databases assembled by “web-crawlers” that contain internet website links and contents of the websites), to color adjustment lookup tables in graphic display systems, to tables used by IP routers to direct packets from inputs to outputs.

As mentioned above, the “memory map” approach is to simply scan the entire contents of a database until a match is found, or the contents of the database are exhausted. In this approach, a single table contains the complete list of keys and corresponding results. Using a memory map can be satisfactory when time is not critical and/or when the database is not excessively large. However, this approach is not satisfactory for many high speed applications, such as IP packet routing.

With reference to FIG. 1, another approach is to organize the data collection as a tree of linked tables 100, 106-112, whereby a portion of the key is searched in the first table 100, and the matching entry provides a link to the next table 108 in the tree. In FIG. 1, each table 100, 106-112 includes a partial key field 102 and a link field 104. At each stage of a search, a selected group of bits from the key (in this case two bits) is compared with the contents of the key fields 102 of a selected table 100 in a currently searched level of the database. When a match is found, the corresponding link field 104 is then used to direct the search to a subsequent table 108, where the search continues for the next group of two bits. In this manner, the search continues to be “routed” through the tree of tables, much the way a packet is routed through a network, until the desired result is found or a dead end is reached. Note that, depending on the nature of the search, it is not always necessary that the entire key be matched against table entries for the search to conclude successfully. For example, a packet router may accept a 32-bit key, but may be configured to route all packets having a certain bit pattern in the first eight bits to the same output.

The simple example of FIG. 1 can be compared to the library example discussed above, wherein the first part of the key (“biography”) is used to find a section of the library, the first letter of the subject (“N”) is used to find a shelf, and then finally the remainder of the key is matched against individual titles to locate the desired volume. Note that the tables 100, 106-112 have different lengths, since not all bit combinations are included in the database.

Often, the approach of FIG. 1 is implemented in practice by storing the various tables 100, 106-112 in separate memory units (“MU's”) that are configured as a pipeline within a processor. After a first portion of a first key has been searched in a first table 100 stored in a first MU, the first key is passed to a subsequent table stored in a subsequent MU 108 according to the link found in the first table 100. While searching of the first key continues in subsequent MU's, a second key is provided to the first MU and the search for that key proceeds through the pipeline of MU's. Use of a pipeline introduces some latency, but enhanced throughput performance is realized, due to the pipeline architecture, the higher searching speeds provided by searching only a portion of the key in each search, and the hardware speed advantage of using on-chip memory.

Nevertheless, the approach of FIG. 1 is limited in speed due to the relatively high number of processor clock cycles required to perform string comparisons. For some applications, this disadvantage is overcome by providing special “ternary content addressable memory” (TCAM) modules in the processor, which function essentially as MU's with dedicated onboard searching sub-processors. Unlike standard memory units that simply accept a memory address and return the data word stored at that address, a TCAM is designed such that the user supplies a key, and the TCAM searches its entire memory to see if that key is stored anywhere in it. The TCAM accepts “wild cards,” which essentially means that the key can be smaller than the record size of the TCAM. For example, if implemented in the example of FIG. 1, each TCAM would search only two bits of each record, while masking the remaining bits with wild cards. If a match to the selected bits of the key were found, the TCAM would return the full contents of the corresponding record that contains the key. Depending on the implementation, the bits masked by the wild cards could contain a link to a subsequent table, or any other information being searched for.

While TCAM's can provide the speed and throughput required for some applications, they are expensive, high in power consumption, and can generate excessive heat, especially when large numbers of TCAM's are used for high speed searching of very large databases. This approach also excludes use of more widely available and less expensive pipeline processors that include on-chip memory units but do not include TCAM's.

Yet another approach is illustrated in FIG. 1B. In this approach, the selected bits from the key are used as address offsets rather than as strings to be searched. In this way, the address pointer is used as a virtual “dedicated search processor,” thereby eliminating the need for a TCAM. Note that the record entries in the tables 114-120 do not contain key bits. In FIG. 1B, the indicated bits 113 are simply the memory offsets of the records in each table.

As can be seen from the simple example in FIG. 1B, this approach requires that all possible bit combinations have entries in each table, which can waste large amounts of memory if many key bit combinations do not have corresponding entries in the database to be searched. Of course, due to the “memory tree” approach it is not necessary to provide an entry for every possible bit combination for the entire key, since an unoccupied record in a table eliminates the need for further tables to be connected to that entry. Nevertheless, this approach provides little opportunity for optimizing the search according to the “occupancy pattern” of keys within the database, and the result can be an unacceptable waste of memory resources.

Use of the memory in the approach of FIG. 1B can be made more efficient by using smaller groups of bits for each table search. For example, FIG. 1B uses only two bits for each table search, and results in relatively few blank entries (using 1 bit would be equivalent to a memory map approach). However, this approach increases the number of required searches, and can slow down the process. Conversely, the search can be made faster and MU's can be used more efficiently if larger bit groups are searched at each stage, but at the cost of more empty records and more wasted memory.

What is needed, therefore, is a method for high speed searching of a large database that does not require TCAMS or other dedicated searching processors, provides optimized memory usage, and yet provides throughput comparable to solutions that use TCAM's or other dedicated processors.

### SUMMARY OF THE INVENTION

The present invention is a method for high speed searching of a large database without using TCAM's or other dedicated searching processors. The method provides optimized memory usage, while at the same time providing throughput comparable to solutions that use TCAM's or other dedicated processors. The objects of the present invention are achieved by using successive groups of bits from a search string or “key” to navigate through a “search tree” of tables in the database, in a manner similar to FIGS. 1A and 1B, except that the bit groups are not constrained to all be the same size, and hence the corresponding sizes of the tables in the tree are not required to be equal in size. Instead, the bit group sizes, the corresponding table sizes, and in some embodiments also the table “types,” as discussed below, are selected according to the information distribution pattern of the data stored in the database so as to maximize both searching speed and memory usage.

Each link in the search “tree” of tables provides information that specifies both the type and size of the linked table. In this way, the processor is not only directed to the next subsequent table, but is also told how the linked table should be used and how many bits from the key should be provided to the linked table.

Specifically, tables in the database include data words that function as “pointer records” providing either direct or indirect links to other tables in the database. Each pointer record includes a “type” code that specifies to which of a group of “types” the next subsequent table in the tree belongs. At least one of the selectable table types uses bits from the key as an address offset, and the type codes in the pointer records that point to this type of “address offset” table further specify the size of the linked table and the number of key bits to be used as the address offset. Navigation through these address offset tables is highly efficient, because, in effect, the instruction pointer of the processor is being used as if it were a dedicated search co-processor.

In some embodiments, only address offset tables are included, and the type fields in the pointer records are used only to specify the sizes of the linked tables. Other embodiments of the present invention allow more than one type of table to be included within the database tree, such as memory mapped tables and string search tables, in addition to address offset tables. In these embodiments, the “type” code included in each pointer record includes bits that indicate the type of table to which the associated table link is pointing. In some of these embodiments, the first few bits of the type code indicate the general type of the linked table, and the remaining bits provide more specific information, depending on the type of linked table. For example, in some embodiments, if the first bit of the type code is a zero, then the linked table is an address offset table as described above, and the remaining bits in the type code indicate how many bits from the key should be used as the address offset for the linked table.

In various embodiments, for at least some table types other than address offset tables, the number of key bits to be used by the linked table is indicated in the table itself, or in a separate pointer to the table (in the case of indirect pointing).

The present invention can be very powerful when applied to searches where the key is a series of bit groups of varying sizes having specific meanings, which is a common situation that arises in packet routing, color mapping, and other applications. By analogy, consider the routing of physical US mail using “zip” codes. A US zip code is a series of 9 decimal digits. The first three digits direct a letter to a sectional mail sorting facility for a certain area. The fourth and fifth digits represent a group of delivery addresses within the area, and the last four digits represent a geographic segment within a group of delivery addresses that typically is served by a single mail carrier. When directing a piece of mail, the initial three digits are considered first, and the letter is sent to the appropriate sectional facility, UNLESS it is already located in the area served by that sectional facility, in which case the next two digits are considered, and possibly the final four digits, before the letter is finally routed.

Of course, the process of physical mail routing does not fall within the scope of the present invention, but it may serve a useful analogy for understanding some embodiments of the present invention, such as packet routing. A given packet router may by assigned to a certain section of the network, and may have outputs connected to local nodes in that section and/or to other local routers that serve smaller subsections within that section. The router may also have connections to other routers that serve other sub-sections. A specific group of bits in the packet delivery address (for example the most significant four bits) may indicate to which section of the network the packet is directed, while other groups of (less significant) bits may provide information regarding smaller subsections, and finally the address of the individual destination node. In such a case, if the destination address is in a different section of the network, then the output port will be assigned after consideration of only the first few bits of the address. On the other hand, if the destination address is in the same section as the router, then additional groups of bits will be considered. Note that the process of assigning a packet to a router output port is sometimes referred to as applying “rules” to the packet's destination address, but the process is equivalent to matching the packet's destination address with an entry in a database and retrieving the assigned output port from the database.

In applying the present invention to such a case, the table sizes would typically be assigned according to the bit groupings in the packet addresses. For example, if the first four bits indicate the primary section of the network where the destination node resides, the first table may contain sixteen entries corresponding to all possible combinations of the first four bits. Some entries may be empty, and the rest will direct the packet to the appropriate output leading to the router that handles that section, except when the first four bits refer to the section to which the router belongs. In that case, the table entry will point to another table whose size will correspond to the size of the next group of bits in the address. Several address offset tables may be quickly searched in succession simply by using the groups of key bits as address offsets. The search may also include one or more string searches and/or data lookups in one or more memory map tables. Finally, the search will terminate with an entry containing the output port ID to which the packet should be routed. In other applications, a similar search may terminate with a pointer to a location in external DDR memory where the information being sought for is stored.

The present invention is a method for performing a search within a data collection to locate a target result that corresponds to a key, the key including a plurality of key bits. The method includes creating a plurality of tables in non-transient media, each table being configured to process a group of bits from the key, where said processing yields a processing result, providing table links that connect the tables to form a search tree, each table link being at least part of a processing result for a preceding table, each table link including information specifying a location of a subsequent table pointed to by the table link and a bit assignment for the subsequent table, the bit assignment being a number of bits from the key to be processed by the subsequent table, the tables, table links, and bit assignments being selected according to a distribution of information within the data collection, processing a first group of bits from the key using a first table in the search tree to obtain a first processing result, if the first processing result is a first table link, obtaining from the first table link the location and the bit assignment of the subsequent table to which the first table link points, and processing a next group of key bits using the subsequent table pointed to by the first table link, the next group of key bits having a number of bits equal to the bit assignment of the subsequent table, and successively processing next groups of bits from the key using subsequent tables pointed to by table pointers until a processing result is obtained that provides the target result.

In embodiments, each table link includes a type field and a link field, the type field containing information specifying how the subsequent table pointed to by the table link will process bits from the key, the link field containing information that can be used to locate the subsequent table to which the table link points.

In some embodiments, at least one of the tables is an address offset table that processes bits from the key by using the bits as an address offset that is added to a base address of the address offset table to locate a data record in the address offset table from which a processing result can be derived. In some of these embodiments each entry in the address offset table is a single data word.

In other of these embodiments, at least one of the table links includes a type field containing data specifying that the table link is pointing to an address offset table, the type field further provides the bit assignment of the address offset table to which the table link is pointing, and the table link further includes a link field containing information that can be used to locate the address offset table to which the table link is pointing. And in some of these embodiments the table link is a single data record entry in a table, the type field includes one bit indicating that the table link is pointing to an address offset table and a plurality of bits that are a binary representation of the bit assignment of the address offset table to which the table link is pointing, and the link field contains a base address of the address offset table to which the table link is pointing.

In various embodiments, at least one of the tables is a string comparison table for which processing a group of bits from the key includes comparing the group of key bits with a comparison value and providing a first processing result if a match is found between the group of key bits and the comparison value. In some of these embodiments the string comparison table provides a second processing result if a match is not found between the key bits and the comparison value. In other of these embodiments if no match is found between the key bits and the comparison value, the key bits are compared with a second comparison value, and a second processing result is provided if a match is found between the key bits and the second comparison value.

In still other of these embodiments each string comparison table includes a first data word containing the bit assignment and the comparison value of the string comparison table, a second data word that can be used to obtain the processing result if a match is found between the key bits and the comparison value, and a third data word that specifies a next step in the search if a match is not found between the key bits and the comparison value. And in some of these embodiments the third data word is able to specify that the same key bits should be processed by a subsequent string comparison table if no match is found between the key bits and the comparison value.

In certain embodiments the search is performed by a processor and at least one of the tables is stored in a memory unit included within the processor. In some of these embodiments at least one of the tables is a memory mapped table located in memory not included within the processor, and the memory mapped processor processes bits from the key by using the bits as an address offset that is added to a base address of the memory mapped table to locate a data record in the address offset table from which a processing result can be derived. In other of these embodiments each entry in the memory mapped table is a single data word.

In still other of these embodiments at least one of the table links includes a type field containing data specifying that the table link is pointing to a memory mapped table, the table link further including a link field containing information that can be used to locate a pointer that points to the memory mapped table to which the table link is pointing. And in some of these embodiments the table link is a single data record in a table and the pointer includes a plurality of data words that specify the bit assignment and the location of the memory mapped table.

In yet other of these embodiments a plurality of memory units are included within the processor, and at least one table located in a first of the memory units can provide a processing result that is an instruction to continue the search on a second of the memory units. In still other of these embodiments the processing result includes information that can be used to locate a table link in the second of the memory units, the table link pointing to a subsequent table in the second of the memory units where the search is to be continued.

In yet other of these embodiments the processing result includes a type field indicating that it is an instruction to move the search from the first memory unit to another memory unit and an offset field that specifies the identity of the second of the memory units.

And in some of these embodiments the processor is a pipeline processor that includes a plurality of internal memory units, and the method further includes using at least one table located on a first memory unit of the processor to begin a second search for a second target result corresponding to a second key as soon as the processing of bits from the key is completed on the first memory unit.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a block diagram illustrating a string comparison search of the prior art;

FIG. 1B is a block diagram illustrating an address offset search of the prior art;

FIG. 2 is a block diagram illustrating an embodiment of the present invention that uses only address offset tables;

FIG. 3A is a block diagram illustrating the basic structure of a data word included in a table link in an embodiment of the present invention;

FIG. 3B is a block diagram illustrating the basic structure of a table link to an address offset table in an embodiment of the present invention;

FIG. 3C is a block diagram illustrating the basic structure of a table link to a string comparison table in an embodiment of the present invention;

FIG. 3D is a block diagram illustrating the basic structure of a data word included in a table link to a memory mapped table in an embodiment of the present invention;

FIG. 3E is a block diagram illustrating the basic structure of an instruction specifying that a search should continue on a different memory unit in an embodiment of the present invention;

FIG. 4A is a block diagram illustrating the basic structure of an address offset table in an embodiment of the present invention;

FIG. 4B is a block diagram illustrating the basic structure of a string comparison table in an embodiment of the present invention;

FIG. 4C is a block diagram illustrating the basic structure of an indirect pointer to a memory mapped table in an embodiment of the present invention;

FIG. 5A is a block diagram of a search executed by a processor in an embodiment of the present invention that proceeds in a search tree of tables stored in memory units included within the processor and then terminates in a leaf node located in memory that is external to the processor;

FIG. 5B is a block diagram of a search executed by a processor in an embodiment of the present invention that proceeds in a search tree of tables stored in memory units included within the processor and then terminates in a memory mapped table located in memory that is external to the processor;

FIG. 5C is a block diagram of a search executed by a processor in an embodiment of the present invention that proceeds in a search tree of tables stored in memory units included within the processor, continues to a string search table, and then terminates in memory that is external to the processor in either a leaf node or a memory mapped table according respectively to whether the string search table finds a match or not;

FIG. 5D is a block diagram of a search executed by a processor in an embodiment of the present invention that proceeds in a search tree of tables stored in memory units included within the processor, continues to a string search table, and then terminates in memory that is external to the processor in either of two memory mapped tables according to whether the string search table finds a match or not; and

FIG. 5E is a block diagram of a search executed by a processor in an embodiment of the present invention that proceeds in a first search tree of tables stored in memory units included within the processor, continues to a string search table, and then, according respectively to whether the string search table finds a match or not, terminates either in a leaf node in memory that is external to the processor or in a second search tree of tables stored in memory units included within the processor.

### DETAILED DESCRIPTION

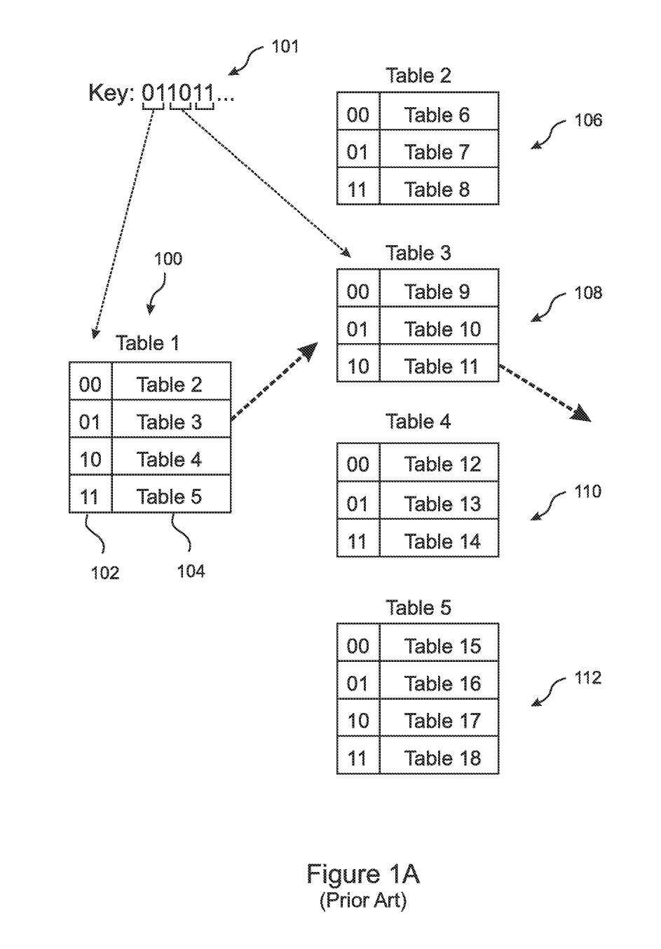

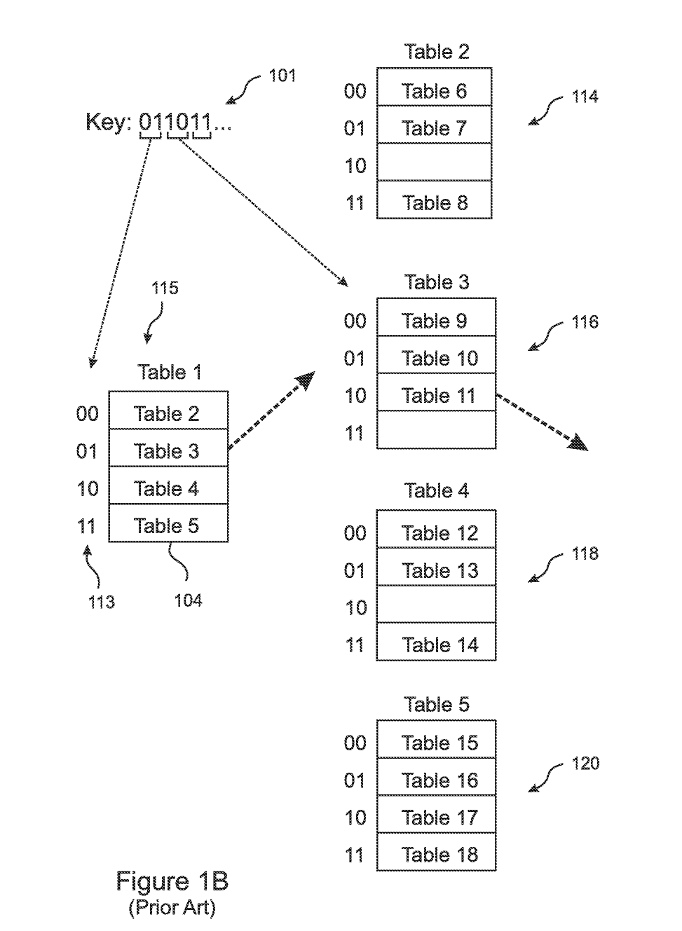

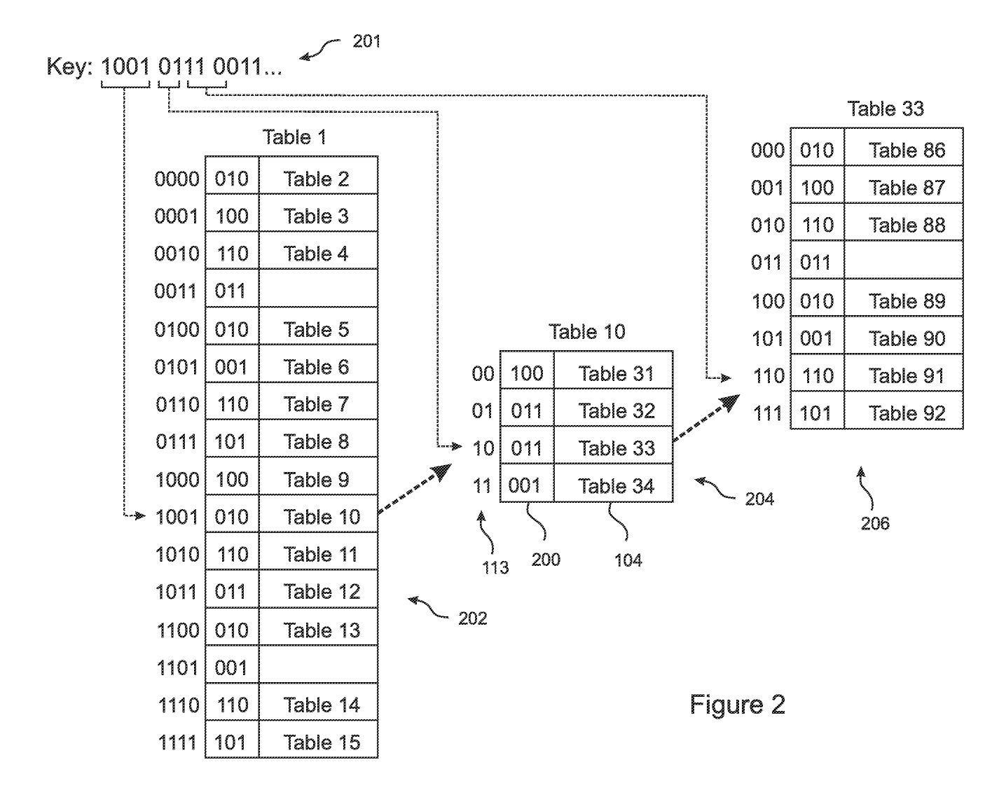

The present invention is a method for high speed searching of a large database without using TCAM's or other dedicated searching processors. The method provides optimized memory usage, while at the same time providing throughput comparable to solutions that use TCAM's or other dedicated processors. With reference to FIG. 2, the objects of the present invention are achieved by using successive groups of bits from a search string or “key” 201 to navigate through a “search tree” of tables 202-206 in the database, in a manner similar to FIGS. 1A and 1B, except that the bit groups are not constrained to all be the same size, and hence the corresponding sizes of the tables 202-206 in the tree are not required to be equal in size. Instead, the bit group sizes, the corresponding table sizes, and in some embodiments also the table “types,” as discussed below, are selected according to the information distribution pattern of the data stored in the database, thereby maximizing both searching speed and memory usage.

Each link in the search “tree” of tables provides information that specifies both the type and size of the linked table. In this way, the processor is not only directed to the next subsequent table, but is also told how the linked table should be used and how many bits from the key should be provided to the linked table.

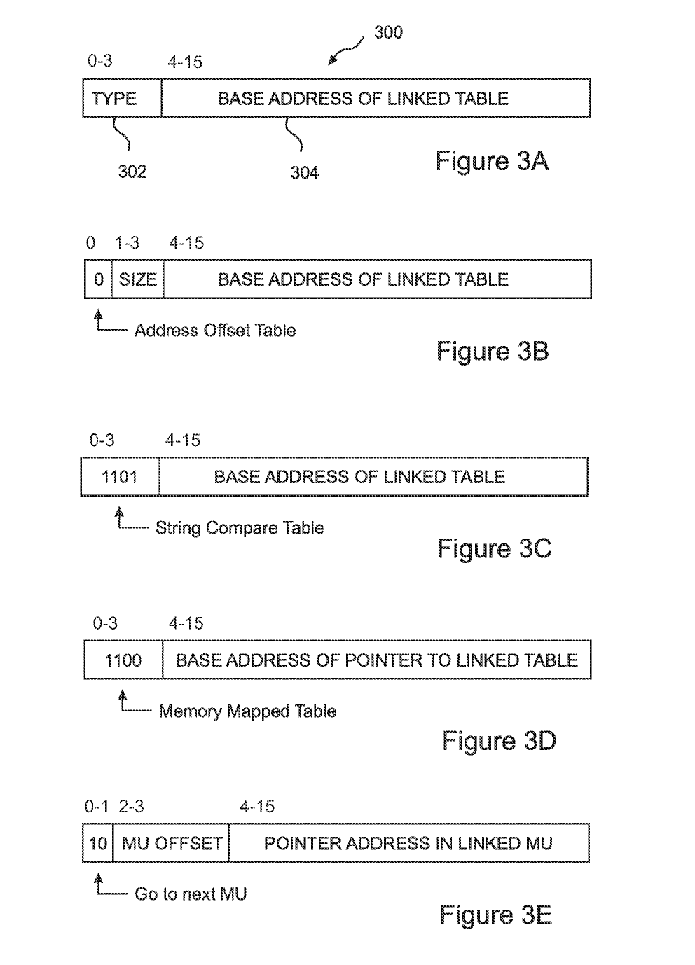

With reference to FIG. 3A, tables in the database include data words that function as “pointer records” 300 providing either direct or indirect links to other tables in the database. Each pointer record 300 includes a “type” code 302 in addition to the base address 304 of the linked table, where the type code 302 specifies to which of a group of “types” the table located at the indicated base address 304 belongs. At least one of the selectable table types uses bits from the key as an address offset, and the type codes in the pointer records that point to this type of “address offset” table further specify the size of the linked table and the number of key bits to be used as the address offset. Navigation through these address offset tables is highly efficient, because, in effect, the instruction pointer of the processor is being used as if it were a dedicated search co-processor. Memory usage is efficient, because the use of variable table sizes minimizes the number of blank records in the tables.

The present invention can be very powerful when applied to searches where the key 201 is a series of bit groups of varying sizes having specific meanings, which is a common situation that arises in packet routing, color mapping, and other applications. For example, a given packet router may by assigned to a certain section of a network, and may have outputs connected to local nodes in that section and/or to other local routers that serve smaller subsections within that section. The router may also have connections to other routers that serve other sections. A specific group of bits in the packet delivery address (for example the most significant four bits) may indicate to which section of the network the packet is directed, while other groups of (less significant) bits may provide information regarding smaller subsections, and finally the address of the individual destination node. In such a case, if the destination address is in a different section of the network, then the output port will be assigned after consideration of only the first few bits of the address. On the other hand, if the destination address is in the same section as the router, then additional groups of bits will be considered.

In applying the present invention to such a case, the table sizes would typically be assigned according to the bit groupings in the packet addresses. For example, with reference again to FIG. 2, if the first four bits indicate the section of the network where the destination node resides, the first table 202 may contain sixteen entries, corresponding to all possible combinations of the first four bits. Some entries may be empty, and the rest will direct the packet to the appropriate output leading to the router that handles that section, except when the first four bits refer to the section to which the router belongs. In that case, the table entry will point to another table 204 whose size will correspond to the size of the next group of bits in the address. Several tables may be searched in succession using the groups of bits as address offsets.

In the specific example of FIG. 2, only memory offset tables are included, and each record includes a three-bit “type” field and a table link field, where the type field indicates the size of the table to which the link field points (and the number of key bits to be provided to the next table). As mentioned above, embodiments of the present invention provide further searching optimization by allowing more than one type of table and corresponding search strategy to be included within the search tree. In these embodiments, the “type” code 302 included in each pointer record indicates the type of table to which the associated table link is pointing. In some of these embodiments, the first one or two bits of the type code 302 indicate the general type of the linked table, and the remaining bits provide more specific information, depending on the type of linked table.

FIGS. 3A-3E illustrate pointer records in an embodiment of the present invention that point to different types of tables. In this embodiment, the word size, and hence the record size, is 16 bits. With reference to FIG. 3A, the first four bits of a pointer record in this embodiment are used as the type field. Note that the “type” field is NOT describing the type of table in which the record is stored. It is describing the type of table that the record points to. The remaining 12 bits contain the base address of the linked table.

With reference to FIG. 3B, in this embodiment if the first bit of the type field is zero, then the record points to an address offset table, and the remaining three bits of the type field indicate the size of the address offset table that is pointed to. For example, if bits 1-3 are 010, then the linked table will have four entries, and will accept the next two bits of the key as the address offset. For many applications, the majority of the data words in the tables will be single pointer records of this type. These could be considered “normal” pointer records that are processed very quickly by simple memory addressing steps, while other kinds of pointer records require more processor cycles for “special handling.”

With reference to FIG. 3C, in this embodiment if the type field is 1101, then the pointer record points to a string comparison table.

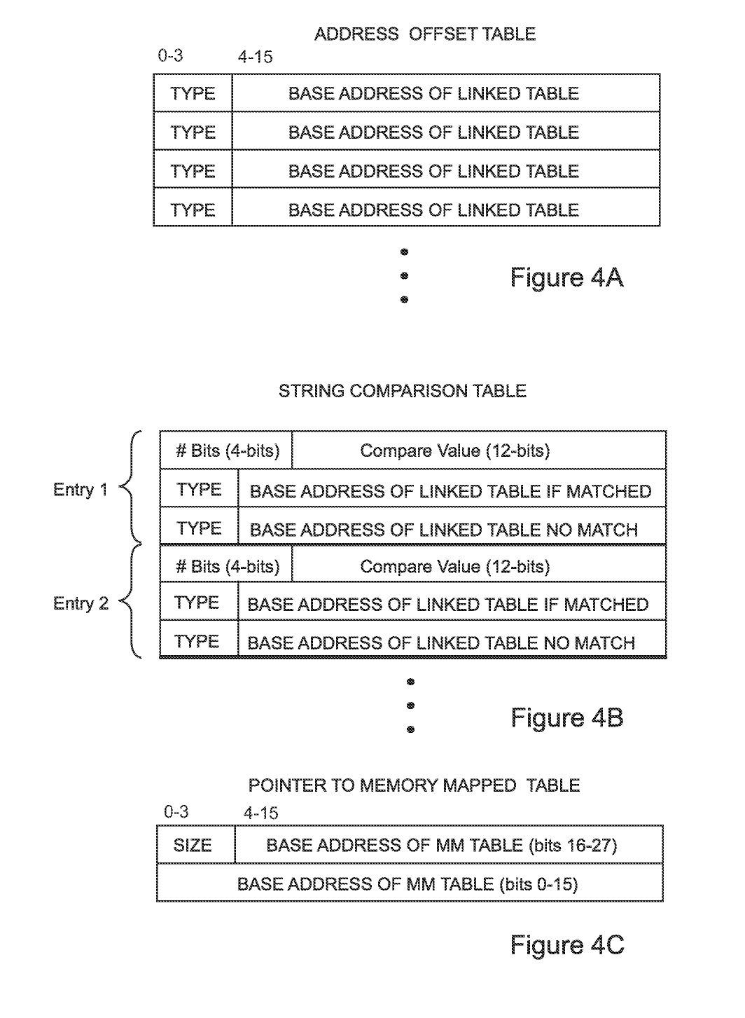

With reference to FIG. 3D, if the type field is 1100, then the pointer record points to a separate pointer, which in turn points to a “memory mapped” table. This “indirect addressing” is discussed in more detail with reference to FIG. 4C.

And with reference to FIG. 3E, if the first two bits of the type field are 10, then the pointer record directs the search to a subsequent memory unit (“MU”). The third and fourth bits of the type field allow the pointer to point to any of the next four MU's on the processor, and the pointer address points to a location in the selected memory unit that contains a pointer record of the type illustrated in FIG. 3A giving the type and base address of the table to be searched on that MU.

With reference to FIG. 4A, in the embodiment of FIGS. 3A-3E an address offset table will typically contain only single record entries that point to other tables according to FIG. 3A. As mentioned above, in some embodiments the majority of the tables are address offset tables, and so the majority of entries in these tables are pointers to other address offset tables according to FIG. 3B.

With reference to FIG. 4B, in the embodiment of FIGS. 3A-3E each entry in a string comparison table includes three data words. The first four bits of the first data word indicate the number of bits to be compared (any remaining bits being “wild cards”) and the remaining 12 bits include the compare value to which the indicated number of bits from the key will be compared. The second and third data words contain pointer records of the type illustrated in FIG. 3A, where the second data word is used if a match is found between the key bits and the compare value, and the third pointer record is used if no such match is found. The entry thereby provides an “if-then-else” logic. In embodiments, if no match is found and if the third data word is null the string compare continues with the next entry in the string search table.

With reference to FIG. 4C, in some embodiments memory mapped tables are located in DDR memory external to the processor (and not in an MU of the processor), thereby requiring a larger base address. In some of these embodiments, the pointer record points to a small pointer table having the format shown in FIG. 4C, whereby the pointer table points to the external memory mapped table. In the embodiment of FIG. 4C, the pointer table includes two data words, where the first four bits of the first data word indicate the number of key bits to pass to the memory mapped table (and thereby the size of the memory mapped table), the remaining bits of the first data word contain the most significant 12 bits of the base address, and the second data word contains the least significant 16 bits of the base address.

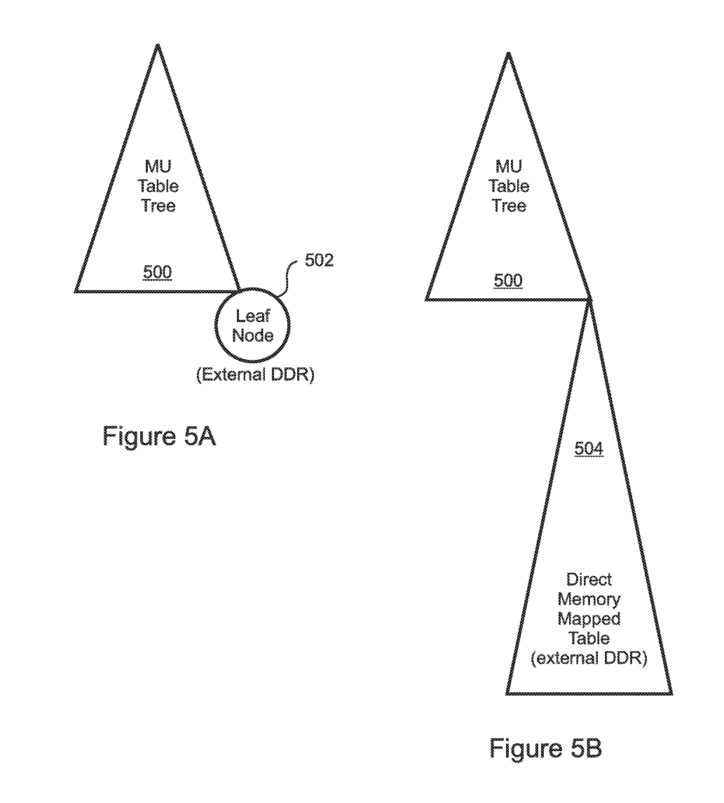

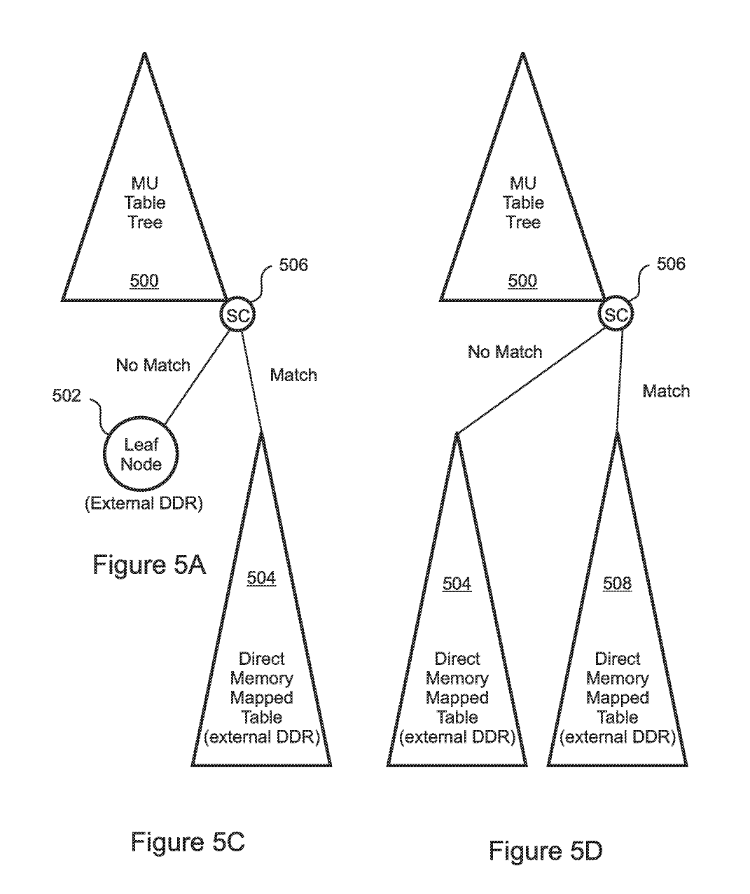

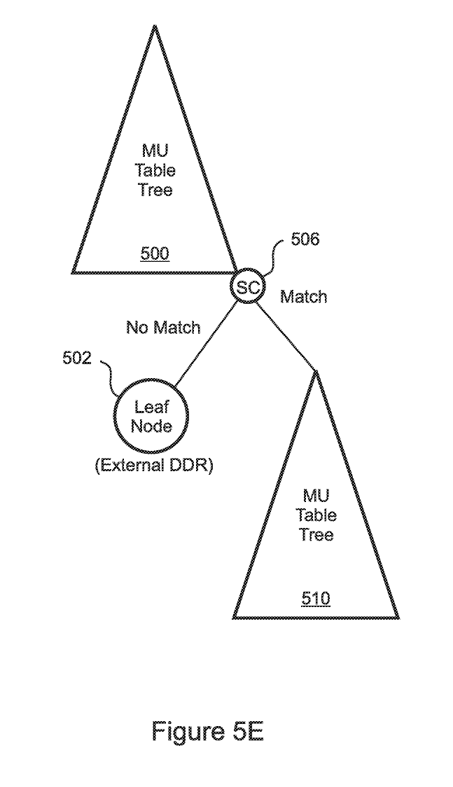

FIGS. 5A through 5E illustrate examples of searching patterns that can be implemented by embodiments of the present invention. In FIG. 5A, a search through a tree of tables 500 stored in MU's within a pipeline processor processes bits in the key until the tree terminates with a pointer to a “leaf node” table 502 in external DDR memory, where the leaf node contains the information being searched for. In FIG. 5B a similar search through a tree of tables 500 stored in MU's terminates with a pointer to a memory mapped table 504 stored in external DDR memory, where a final group of key bits is used to located the desired data.

In FIG. 5C, a search through a tree of tables 500 stored in MU's terminates in a string comparison 506. If there is no match, the search performs no further searching but simply terminates in a leaf node 502 in external DDR memory. If there is a match, the search is directed to a memory mapped table 504 in external DDR memory where additional bits from the key are used to locate the desired data.

In FIG. 5D, a search through a tree of tables 500 stored in MU's terminates in a string comparison 506. If there is no match, the search is directed to a first memory mapped table 504 in external DDR memory where additional bits from the key are used to locate the desired data. If there is a match, the search is directed to a second memory mapped table 508 in external DDR memory where additional bits from the key are used to locate the desired data.

In FIG. 5E, a search through a first tree of tables 500 stored in MU's terminates in a string comparison 506. If there is no match, the search performs no further searching but simply terminates in a leaf node 502 in external DDR memory. If there is a match, the search is directed to continue in a second tree of tables 510 stored in MU's.

Note that in some embodiments, the entire key is passed from MU to MU as the search progresses, while in other embodiments each MU receives only the bits that will be used to search tables stored on that MU. In the first case, processor overhead is reduced but the burden on the data links between the processing unit and the MU's is increased, while in the second case data communication between the processor and the MU's is reduced at the expense of more processor unit overhead in parsing the key and transmitting only specific bit groups to the MU's.

Note also that a tradeoff between MU usage, throughput, and latency can be optimized according to how many tables are stored in each MU. For example, throughput can be maximized at the expense of increased MU usage and latency if a large number of MU's are dedicated to the search, such that each MU contains only a single table. This allows a new key to be introduced into the MU pipeline after each table search. On the other hand, the search can be performed using fewer MU's and reduced latency, at the expense of lower throughput, if each MU contains a plurality of tables, so that a new key can be introduced into the pipeline only when the plurality of searches performed within a single MU has been completed.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for performing a search within a data collection to locate a target result that corresponds to a key, the key including a plurality of key bits, the method comprising:
creating a plurality of tables in non-transient media, each table being configured to process a group of bits from the key, where said processing yields a processing result;
providing table links that connect the tables to form a search tree, each table link being at least part of a processing result for a preceding table, each table link including information specifying a location of a subsequent table pointed to by the table link and a bit assignment for the subsequent table, the bit assignment being a number of bits from the key to be processed by the subsequent table, the tables, table links, and bit assignments being selected according to a distribution of information within the data collection;
processing a first group of bits from the key using a first table in the search tree to obtain a first processing result;
if the first processing result is a first table link, obtaining from the first table link the location and the bit assignment of the subsequent table to which the first table link points, and processing a next group of bits from the key using the subsequent table pointed to by the first table link, the next group of bits from the key having a number of bits equal to the bit assignment of the subsequent table; and
successively processing next groups of bits from the key using subsequent tables pointed to by table pointers until a processing result is obtained that provides the target result.

2. The method of claim 1, wherein each table link includes a type field and a link field, the type field containing information specifying how the subsequent table pointed to by the table link will process bits from the key, the link field containing information that can be used to locate the subsequent table to which the table link points.

3. The method of claim 1, wherein at least one of the tables is an address offset table that processes bits from the key by using the bits as an address offset that is added to a base address of the address offset table to locate a data record in the address offset table from which a processing result can be derived.

4. The method of claim 3, wherein each entry in the address offset table is a single data word.

5. The method of claim 3, wherein:
at least one of the table links includes a type field containing data specifying that the table link is pointing to an address offset table;
the type field further provides the bit assignment of the address offset table to which the table link is pointing; and
the table link further includes a link field containing information that can be used to locate the address offset table to which the table link is pointing.

6. The method of claim 5, wherein:
the table link is a single data record entry in a table;
the type field includes one bit indicating that the table link is pointing to an address offset table and a plurality of bits that are a binary representation of the number of bits from the key assigned to the address offset table to which the table link is pointing; and
the link field contains a base address of the address offset table to which the table link is pointing.

7. The method of claim 1, wherein at least one of the tables is a string comparison table for which processing a group of bits from the key includes:
comparing the group of bits from the key with a comparison value; and
providing a first processing result if a match is found between the group of bits from the key and the comparison value.

8. The method of claim 7, wherein the string comparison table provides a second processing result if a match is not found between the bits from the key and the comparison value.

9. The method of claim 7, wherein if no match is found between the bits from the key and the comparison value, the bits from the key are compared with a second comparison value, and a second processing result is provided if a match is found between the bits from the key and the second comparison value.

10. The method of claim 7, wherein each string comparison table includes:
a first data word containing the assignment of bits from the key and the comparison value of the string comparison table;
a second data word that can be used to obtain the processing result if a match is found between the bits from the key and the comparison value; and
a third data word that specifies a next step in the search if a match is not found between the bits from the key and the comparison value.

11. The method of claim 10, wherein the third data word is able to specify that the same bits from the key should be processed by a subsequent string comparison table if no match is found between the bits from the key and the comparison value.

12. The method of claim 1, wherein the search is performed by a processor, and at least one of the tables is stored in a memory unit included within the processor.

13. The method of claim 12, wherein at least one of the tables is a memory mapped table located in memory not included within the processor, and the memory mapped processor processes bits from the key by using the bits as an address offset that is added to a base address of the memory mapped table to locate a data record in the address offset table from which a processing result can be derived.

14. The method of claim 13, wherein each entry in the memory mapped table is a single data word.

15. The method of claim 13, wherein at least one of the table links includes a type field containing data specifying that the table link is pointing to a memory mapped table, the table link further including a link field containing information that can be used to locate a pointer that points to the memory mapped table to which the table link is pointing.

16. The method of claim 15, wherein:
the table link is a single data record in a table; and
the pointer includes a plurality of data words that specify the assignment of bits from the key and the location of the memory mapped table.

17. The method of claim 12, wherein a plurality of memory units are included within the processor, and at least one table located in a first of the memory unit can provide a processing result that is an instruction to continue the search on a second of the memory units.

18. The method of claim 17, wherein the processing result includes information that can be used to locate a table link in the second of the memory units, the table link pointing to a subsequent table in the second of the memory units where the search is to be continued.

19. The method of claim 17, wherein the processing result includes:
a type field indicating that it is an instruction to move the search from the first memory unit to another memory unit; and
an offset field that specifies the identity of the second of the memory units.

20. The method of claim 12, wherein the processor is a pipeline processor that includes a plurality of internal memory units, and the method further includes using at least one table located on a first memory unit of the processor to begin a second search for a second target result corresponding to a second key as soon as the processing of bits from the key is completed on the first memory unit.
